(19) United States
(12) Patent Application Publication
(10) Pub. No.: US 2023/0123029 A1
(43) Pub. Date: Apr. 20, 2023

(54) ZIF NANOPARTICLE CONTAINING TRI-LIGANDS, THE METHOD OF MANUFACTURING THE SAME, MIXED MATRIX MEMBRANE COMPRISING THE SAME AND METHOD OF SEPARATING GAS USING THE MEMBRANE

(71) Applicant: SOGANG UNIVERSITY RESEARCH & BUSINESS DEVELOPMENT FOUNDATION, Seoul (KR)

(72) Inventors: Jong Suk LEE, Seoul (KR); He Seong AN, Seoul (KR); Jin Won LEE, Seoul (KR); Jeong Geol NA, Seoul (KR)

(21) Appl. No.: 17/505,835

(22) Filed: Oct. 20, 2021

(51) Int. Cl. B01J 20/22; B01J 20/26; B01J 20/28; C07F 3/06; B01D 53/22; B01D 69/14; B01D 71/62; B01D 71/02

(52) U.S. Cl. CPC B01J 20/226; B01J 20/26; B01J 20/28033; C07F 3/06; B01D 53/228; B01D 69/148; B01D 69/147; B01D 71/62; B01D 71/022

(57) ABSTRACT

The present invention relates to ZIF nanoparticles introduced with three kinds of ligands, a method for preparing the same, a hybrid membrane including the same, and a gas separation method using the hybrid membrane. Nanoparticles of a zeolitic imidazolate framework (ZIF) into which three kinds of ligands are introduced, the nanoparticles comprising metal ions, and an organic ligand bound to the metal ion, wherein the organic ligand comprises an imidazole-based first organic ligand, alkylamine-based second organic ligand, and third organic ligand comprising at least one amine group substituted on the ring.

### DISCUSSION OF RELATED ART

A metal organic framework (MOF) is a relatively new hybrid organic-inorganic material which is a microporous crystalline material composed of metal atoms or metal clusters and organic ligands connecting them by coordination bonds. The pore size and physical/chemical properties of MOFs can be controlled by selection of appropriate metal atoms and organic ligands. Because of the special properties of these MOFs, they show potential applications as gas storage and/or absorption, catalysis, and separation membranes.

The zeolitic imidazolate framework (ZIF) is a sub-concept of MOF particles and has the advantage of allowing easy control of the particle surface area, pore size, and chemical properties by using organic ligands containing various functional groups.

### SUMMARY

The present disclosure provides a ZIF nanoparticle containing tri-ligands, the method of manufacturing the same, mixed matrix membrane comprising the same, and method of separating gas using the membrane, which has excellent CO₂ separation performance, dispersibility, and compatibility with polymers, and it is designed to develop a CO₂-selective high-performance hybrid membrane.

The present disclosure provides nanoparticles of a zeolitic imidazolate framework (ZIF) into which three kinds of ligands are introduced. The nanoparticles include metal ions; and an organic ligand bound to the metal ion, wherein the organic ligand comprises an imidazole-based first organic ligand, alkylamine-based second organic ligand, and third organic ligand comprising at least one amine group substituted on the ring.

In the organic ligand, the third organic ligand is 20 to 60 mol %.

The organic ligand includes 30 to 80 mol % of the first organic ligand, 3 to 15 mol % of the second organic ligand, and 20 to 60 mol % of the third organic ligand.

The first organic ligand, the second organic ligand, and the third organic ligand are each directly bonded to the metal ion nanoparticles.

The first organic ligand includes at least one of primary, secondary, and tertiary amines, and contains one or more selected from the group of alkylamines having an alkyl chain of any one length of methyl, ethyl, propyl, butyl, pentyl, hexyl, heptyl, octyl, nonyl, decyl, undecyl, dodecyl, propadecyl, butadecyl, pentadecyl, hexadecyl, heptadecyl, octadecyl, and nodadecyl.

The second organic ligand includes at least one selected from 2-methylimidazole, imidazole, ethylimidazole, nitroimidazole, chloromethylimidazole, dichloroimidazole, imidazole-4-carboxamide, aminobenzimidazole, benzimidazole, 5-chlorobenz imidazole, 5,6 dimethylbenzimidazole, methylbenzimidazole, bromobenzimidazole, and nitrobenzimidazole.

The third organic ligand includes at least one selected from amino-1,2,4-triazole, aminoimidazole, 2-aminobenzimidazole and 6-aminobenzimidazole.

The spacing between the (011) crystal planes of the nanoparticles is 12.06 to 11.95 Å, the IR peak of the amine-metal bond of the nanoparticles is 425.5 to 429.5 cm′, the specific surface area of the nanoparticles is 400 to 1000 m² g⁻¹, the pore volume is 0.2 to 0.65 cm³ and the size of the nanoparticles is 80 nm to 120 nm.

The present disclosure also provides a method of manufacturing nanoparticles of a zeolitic imidazolate framework (ZIF) into which three kinds of ligands are introduced. The method includes agitating a metal precursor, an imidazole-based first organic ligand, and an alkylamine-based second organic ligand in a first polar solvent to obtain raw nanoparticles; and substituting at least a portion of the first organic ligand and the second organic ligand of the raw nanoparticles with a third organic ligand comprising at least one amine group substituted on a ring.

The substituting is performed by agitating the raw nanoparticles and the third organic ligand in a second polar solvent.

The metal precursor includes an acetate salt of one or more metals selected from the group consisting of Co, Zn, Sc, Ti, V, Cr, Mn, Fe, Ni, Cu, Y, Zr, Nb, Mo, Tc, Ru, Rh, Pd, Ag, Cd, Lu, Hf, Ta, W, Re, Os, Ir, Pt, Au, Hg, Lr, Rf, db, Sg, Bh, Hs, Mt, Ds, Rg, and Uub, the first polar solvent and the second polar solvent each independently include at least one selected from the group consisting of alcohol, methanol, ethanol, propanol, ethylene glycol, water, dimethylformamide, dimethyl sulfoxide, acetonitrile, and dimethylacetamide.

The present disclosure also provides a hybrid membrane comprising nanoparticles. The hybrid membrane includes 100 parts by weight of a polymer; and a hybrid membrane comprising 30 to 150 parts by weight of the nanoparticles according to anyone from claim 1 to claim 7.

The hybrid membrane has a CO₂/N₂ separation performance of 25 to 60, a CO₂/CO separation performance of 15 to 60, and a CO₂/CH₄ separation performance of 24 to 50 at 1 atmospheric pressure and 35° C.

The present disclosure also provides a gas separation method including separating one or more gases from a mixed gas containing two or more gases using the hybrid membrane.

The difference in molecular size of the gases included in the mixed gas is 0.1 Å to 5 Å, and the mixed gas includes CO₂.

### BRIEF DESCRIPTION OF THE DRAWINGS

FIG. 1 is a view for explaining the concept of the present invention,

FIG. 2 is a ToF-SIMS detection graph of particles synthesized in an experimental example of the present invention,

FIG. 3 is an XRD pattern of particles synthesized in an experimental example of the present invention,

FIG. 4 is an FT-IR spectrum of particles synthesized in an experimental example of the present invention,

FIG. 5 is an N₂ isothermal adsorption graph using BET of particles synthesized in an experimental example of the present invention,

FIG. 6 is an SEM particle photograph of particles synthesized in an experimental example of the present invention,

FIG. 7 is a comparison of the (011) crystal plane peak value and the peak area for the gas of the particles synthesized in the experimental example of the present invention,

FIG. 8 shows the (011) crystal plane peak area changes with respect to the gas of the particles synthesized in the experimental example of the present invention,

FIG. 9 is an SEM cross-sectional photograph of a hybrid membrane prepared in an experimental example of the present invention,

FIG. 10 is a photograph of a hybrid membrane prepared in an experimental example of the present invention,

FIG. 11 is an analysis of Young's modulus and hardness of the hybrid membrane prepared in Experimental Example of the present invention, and

FIG. 12 shows the adsorption amounts of CO₂, N₂, and CH₄ according to a pressure of the hybrid membrane prepared in Experimental Example of the present invention.

### DETAILED DESCRIPTION

In the following description, a ZIF into which three ligands are introduced is referred to as a “nanoparticle”, nanoparticles using 3-amino-1,2,4-triazole (Atz) as the third ligand are called “TAZIF” or “TAZIF8”.

In the following description, zinc as the metal particle, 2-methylimidazole (2mim) as the first ligand, tributylamine as the second ligand, and 3-amino-1,2,4-triazole (Atz) is illustrated by way of example, but the present invention is not limited thereto.

In addition, in the following description, the hybrid membrane is used as a hybrid membrane for separating CO₂ gas, but the use of the hybrid membrane of the present invention is not limited thereto.

The present invention provides nanoparticles with three ligands, 1) by controlling the compatibility between nanoparticles and polymers and the pore size of nanoparticles using an alkyl amine modulator, and 2) by partially substituting a new organic ligand containing an amine group capable of selectively adsorbing CO₂ gas in the nanoparticles. The hybrid separation membrane including nanoparticles has high permeability and high selectivity to CO₂ gas.

Each of the three organic ligands may be connected to a metal ion by a coordination bond.

Nanoparticles introduced with amine groups by reforming have improved CO₂ gas adsorption capacity, and at the same time, pore size is controlled by reforming, thereby enabling selective gas adsorption and permeation. When nanoparticles are synthesized using an amine modulator, the compatibility between the polymer and the nanoparticles is increased, the crystallinity of the nanoparticles is improved, and the pore size of the nanoparticles can be adjusted.

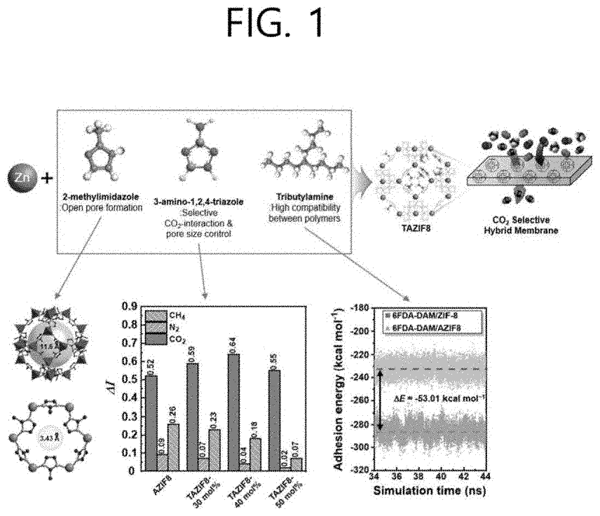

In the present invention, as shown in FIG. 1, raw nanoparticles composed of a coordination bond of zinc (Zn) metal ions and 2-methylimidazole (2mim) are used, and 2mim, an organic ligand containing an amine group, and an amine modulator are used to provide a hybrid separation membrane capable of selective CO₂ gas separation including high particle content by developing novel nanoparticles having three types of organic ligands and mixing them with a polymer matrix.

The nanoparticles according to the present invention include a metal ion and an organic ligand bound thereto. The organic ligand includes an imidazole-based first organic ligand, an alkylamine-based second organic ligand, and a third organic ligand including at least one amine group substituted on a ring.

In the organic ligand, the third organic ligand may be 20 to 60 mol %, 25 to 55 mol %, or 25 to 60 mol %. Alternatively, the organic ligand may be composed of 30 to 80 mol % of the first organic ligand, 3 to 15 mol % of the second organic ligand, and 20 to 60 mol % of the third organic ligand.

Each of the first organic ligand, the second organic ligand, and the third organic ligand is directly bound to a metal ion.

The first organic ligand may include at least one selected from 2-methylimidazole, imidazole, ethylimidazole, nitroimidazole, chloromethylimidazole, dichloroimidazole, imidazole-4-carboxamide, aminobenzimidazole, benzimidazole, 5-chlorobenz imidazole, 5,6 dimethylbenzimidazole, methylbenzimidazole, bromobenzimidazole, and nitrobenzimidazole.

Alternatively, the first organic ligand may include one or more selected from imidazole-based compounds represented by the following Chemical Formula 1 or Chemical Formula 2 but is not limited thereto.

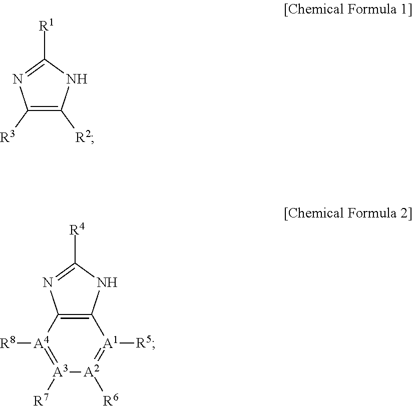

In each of Formula 1 and Formula 2,

R1, R2, R3, R4, R5, R6, R7, and R8 are each independently H, a C1 to C10 linear or branched alkyl group, a halogen, hydroxy, cyano, nitro, an aldehyde group, or a C1 to C10 group,

A1, A2, A3, and A4 are each independently C or N, with the provision that R5, R6, R7, and R8 are present only when A1 and A4 are C.

The second organic ligand may include at least one of primary, secondary, and tertiary amines, and may include one or more selected from the group of alkylamines having an alkyl chain of any one length of methyl, ethyl, propyl, butyl, pentyl, hexyl, heptyl, octyl, nonyl, decyl, undecyl, dodecyl, propadecyl, butadecyl, pentadecyl, hexadecyl, heptadecyl, octadecyl, and nodadecyl.

The third organic ligand may include at least one selected from 3-amino-1,2,4-triazole, aminoimidazole, 2-aminobenzimidazole, and 6-aminobenzimidazole.

The size of the nanoparticles may be 10 nm to 100 nm or 5 nm to 50 nm, and the pore size of the nanoparticles may be 0.1 nm to 1 nm.

The nanoparticles have a (011) crystal plane spacing of 12.06 to 11.95 Å, the IR peak of the amine-metal bond of the nanoparticles is 425.5 to 429.5 cm⁻¹, the specific surface area of the nanoparticles is 400 to 1000 m² g⁻¹, and the pore volume is 0.2 to 0.65 cm³ g⁻¹, and the size of the nanoparticles may be 80 nm to 120 nm.

The method for preparing nanoparticles according to the present invention comprises the steps of (1) stirring a metal precursor, an imidazole-based first organic ligand, and an alkylamine-based second organic ligand in a first polar solvent to obtain raw nanoparticles; and (2) substituting at least a portion of the first organic ligand and the second organic ligand of the raw nanoparticles with a third organic ligand.

In the step of obtaining the raw nanoparticles, the molar ratio of the metal precursor: the first organic ligand: the second organic ligand: the first polar solvent may be 1:1-5:3-10:200-1000.

The mixing temperature is 40° C. to 80° C., and the mixture can be stirred for 2 hours to 20 hours. Thereafter, the obtained raw particles are dried.

In the substitution step, the molar ratio of the raw nanoparticles: the third organic ligand: the second polar solvent is 1:5 to 15:30 to 80, and the mixture is stirred. The mixing temperature is 30° C. to 80° C., and the mixture can be stirred for 2 hours to 20 hours.

After stirring, the precipitate is separated through centrifugation, and then purified and dried to obtain nanoparticles.

Metal precursors may include an acetate salt of one or more metals selected from the group consisting of Co, Zn, Sc, Ti, V, Cr, Mn, Fe, Ni, Cu, Y, Zr, Nb, Mo, Tc, Ru, Rh, Pd, Ag, Cd, Lu, Hf, Ta, W, Re, Os, Ir, Pt, Au, Hg, Lr, Rf, db, Sg, Bh, Hs, Mt, Ds, Rg and Uub.

The first polar solvent and the second polar solvent may independently include one or more selected from the group consisting of alcohol, methanol, ethanol, propanol, ethylene glycol, water, dimethylformamide, dimethylsulfoxide, acetonitrile, and dimethylacetamide.

The hybrid membrane including nanoparticles includes a polymer matrix and nanoparticles dispersed in the polymer matrix. The polymer matrix may include any one selected from the group consisting of polyimide, polysulfone (PSF), polyisosulfone (PES), cellulose acetate (CA), polydimethylsiloxane (PDMS), and polyvinyl acetate (PVAc).

The hybrid membrane can separate gases having a molecular size difference of 0.1 Å to 5 Å from each other, and may be used to separate a gas mixture of a gas set selected from the group of gas sets consisting of C₃H₆/C₃H₈, C₂H₄/C₂H₆, CO₂/CH₄, CO₂/CO, CO₂/N₂, N₂/CH₄, and n-C₄/i-C₄ (n-butane/iso-butane), H₂/CH₄, H₂/C₃H₈ and H₂/C₃H₆. In the separation method, by passing a mixed gas through a hybrid membrane, the gases are separated from each other using a difference in molecular size of the gases included in the mixed gas.

The thickness of the hybrid membrane may be 50 nm to 100 μm or 1 μm to 100 μm.

The hybrid membrane may include 100 parts by weight of a polymer and 30 to 150 parts by weight or 40 to 80 parts by weight of nanoparticles. Alternatively, the nanoparticles in the hybrid membrane may be 20 wt % to 80 wt %, 30 wt % to 70 wt %, or 30 wt % to 50 wt %.

The hybrid membrane may have a CO₂/N₂ separation performance of 25 to 60, a CO₂/CO separation performance of 15 to 60, and a CO₂/CH₄ separation performance of 24 to 50 at 1 atmospheric pressure and 35° C.

Hereinafter, the present invention will be described in detail through experimental examples.

Preparation of Nanoparticles

In a round flask, zinc acetate-based metal salt, 2-methylimidazole (2mim), amine modulator (ie, tri-butyl amine, TBA), and methanol were mixed in a molar ratio of 1:2:5:500 at 65° C. The mixture was stirred at 700 rpm for 12 hours.

After 24 hours, the white precipitate formed was purified using methanol and a centrifuge.

Thereafter, the particles were dried at 100° C. and 200° C. under vacuum conditions for 12 hours each.

The obtained amine modulator-introduced raw nanoparticles (AZIF, AZIF8) were mixed with 3-amino-1,2,4-triazole (ie, Atz) and methanol in a molar ratio of 1:8:45 at 40° C. The mixture was stirred at 700 rpm for 6 hours, 6 hours 30 minutes, 6 hours 40 minutes, 7 hours, and 7 hours 30 minutes, respectively. After stirring, the white precipitate formed was purified using methanol and a centrifuge, and then dried at 100° C. and 120° C. under vacuum conditions for 12 hours, respectively, to obtain nanoparticles, that is, TAZIF (TAZIF8).

Analysis of Molar Ratio and Binding Form of Organic Ligands

The molar ratio of the organic ligand contained in the synthesized nanoparticles was calculated through ¹H NMR analysis. As the equipment, Unity Inova (500 MHz) was used, and an analysis solution was prepared by dissolving each particle in a H₂SO₄/CDCl₃ (10/90 v/v) solution.

As shown in Table 1, it was confirmed that the molar ratio of 2mim decreased and the molar ratio of Atz increased in the TAZIF8 particles stirred using Atz for up to 6 hours and 40 minutes without significant change in the amine modulator group in the organic ligand. However, in the TAZIF particles stirred for 7 hours and 7 hours 30 minutes, the molar ratio of 2mim and TBA compared to the raw nanoparticles rapidly decreased, confirming that most of the organic ligands in the nanoparticles were substituted with Atz. Particles subjected to Atz reaction for 6 hours, 6 hours 30 minutes, 6 hours 40 minutes, 7 hours, and 7 hours 30 minutes are named TAZIF8-30 mol %, TAZIF8-40 mol %, TAZIF8-50 mol %, TAZIF8-90 mol % and TAZIF8-99 mol %.

TABLE 1

| | 2mim | TBA | Atz | Total |
|---|---|---|---|---|
| Sample | (mol %) | (mol %) | (mol %) | (mol %) |
| Raw nanoparticles | 93.9 | 6.1 | — | 100 |
| TAZIF8 30 mol % | 60.7 | 6.1 | 33.2 | 100 |
| (6 hours reaction) | | | | |
| TAZIF8 40 mol % | 52.2 | 5.3 | 42.5 | 100 |
| (6 hours 30 minutes | | | | |
| reaction) | | | | |
| TAZIF8 50 mol % | 42.0 | 5.7 | 52.3 | 100 |
| (6 hours 40 minutes | | | | |
| reaction) | | | | |
| TAZIF8 90 mol % | 8.6 | 1.9 | 89.5 | 100 |
| (7 hours reaction) | | | | |
| TAZIF8 99 mol % | 1.1 | 0.2 | 98.7 | 100 |
| (7 hours 30 minutes | | | | |
| reaction) | | | | |

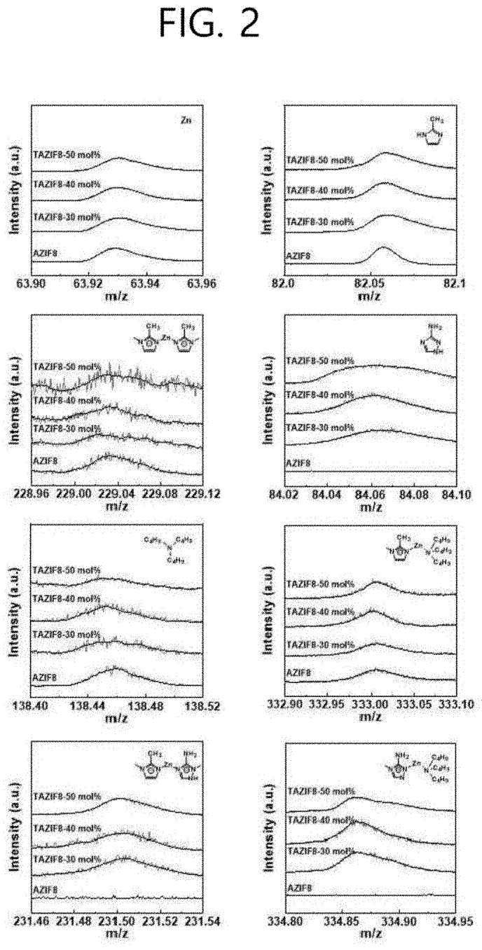

In order to check the presence or absence of precise coordination bond between Zn metal ions and organic ligands in TAZIF8 nanoparticles, by using time of flight secondary ion mass spectrometry (ToF-SIMS), the components and types of coordination bonds in the synthetic particles were confirmed. The instrument was applied with a 30 keV BI³⁺ cluster ion beam using IONI-TOF GmbH TOF SIMS 5. As shown in FIG. 2, Zn metal ions (65.38 g mol⁻¹), 2mim (82.1 g mol⁻¹), and TBA (185.36 g mol⁻¹) were detected in all the raw nanoparticles and nanoparticles, including the Atz group and Atz (84.08 g mol⁻¹) was also detected in TAZIF8 nanoparticles. In addition, Zn(2mim)2(229.58 g mol⁻¹) maintaining the SOD basic structure of the particles and TBA coordinating with Zn metal ions in the raw nanoparticles were also identified (Zn(2mim)(TBA), 332.84 g mol⁻¹). Zn(2mim)(Atz)(231.56 g mol⁻¹) and Zn(TBA)(Atz)(334.82 g mol⁻¹) were detected in all TAZIF8 nanoparticles to which the Atz group was introduced. Based on these, it is confirmed that 2mim maintaining the basic structure of SOD in TAZIF8 nanoparticles, TBA having high compatibility with polymers, and Atz group having selective interaction with CO₂ and controlling the pore size in the nanoparticles are well bound to the Zn metal ion.

Analysis of the Crystalline Structure of Nanoparticles

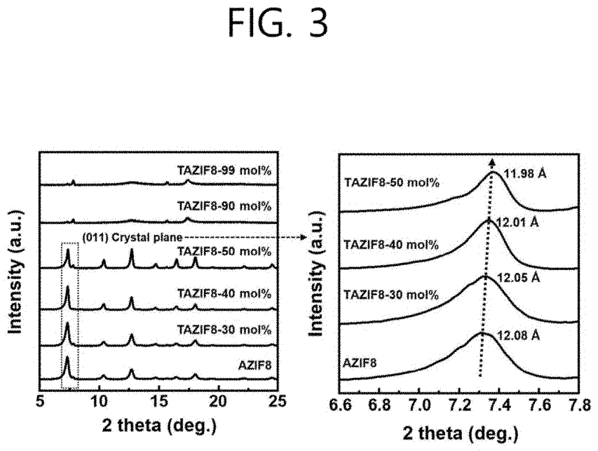

In order to determine the crystalline structure of the synthesized TAZIF8 particles, X-ray diffraction analysis (X-ray Diffraction, XRD) was used and compared with the raw nanoparticles (FIG. 3). The instrument was using a Rigaku D/Max-2500H running at 45 kV and 40 mA with Cu-Kα radiation to collect results at 1° min⁻¹ intervals between 5°-50°. It was confirmed that the raw nanoparticles and the TAZIF8-30 mol %, TAZIF8-40 mol %, and TAZIF8-50 mol % particles into which Atz was introduced maintained the sodalite (SOD) structure, which is the basic structure. However, it was confirmed that the TAZIF8 particles introduced with a molar ratio of about 90 or more broke the existing SOD structure. Also, as a result of analyzing the (011) crystal plane spacing of each particle, it was confirmed that the (011) crystal plane spacing of TAZIF8 particles gradually decreased as the Atz introduction amount increased from 30 mol ratio to 50 mol ratio. This means that the pore size of the particles gradually decreases as the amount of the Atz organic ligand is increased, and it can be confirmed that selective gas permeation of the TAZIF8 particles is possible.

Identification of Atz Organic Ligands within TAZIF

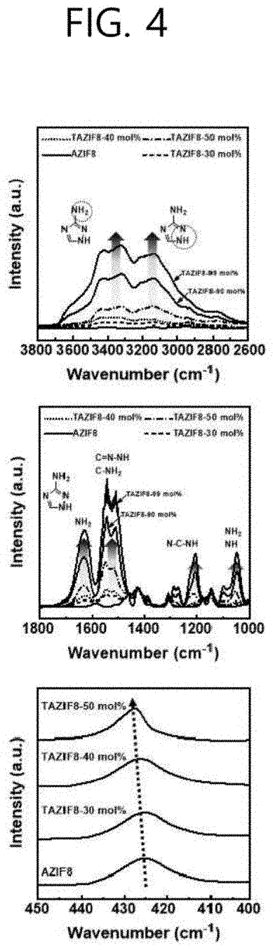

In order to confirm the presence of the introduced Atz organic ligand in the TAZIF8 particles, Fourier transform infrared spectroscopy (FT-IR) was analyzed. The instrument used Nicolet 380 FT-IR spectroscopy to scan a wavenumber of 4,000-400 cm⁻¹ at a magnification of 2 cm⁻¹. As the amount of Atz introduced increased, it was confirmed that the area of the detection peak at the wavenumbers of 3,500-3,000, 1,650, and 1,050 cm⁻¹ representing the secondary amine group in the Atz group increased (FIG. 4).

In addition, it was confirmed that the area of the detection peak at the wavenumbers of 3,100, 1,550-1,500, and 1,210 cm⁻¹ representing the amino functional group (—NH—N—) group in Atz increased. As shown in FIG. 4, in the case of raw nanoparticles, a peak related to the binding (N—Zn) between the amine and metal ion of the organic linkage (N—Zn) appears at 424.3 cm⁻¹. The wavenumber of the corresponding peak increases together, and the TAZIF8-50 mol % nanoparticles move to 427.5 cm⁻¹, showing a difference of about 3.2 cm⁻¹. Through this, it was confirmed that the bonding strength between the metal and the organic ligand was relatively increased by the introduction of Atz, and it was confirmed that the developed TAZIF8 nanoparticles had a more limited pore size than the raw nanomaterials.

TAZIF Surface Area Analysis

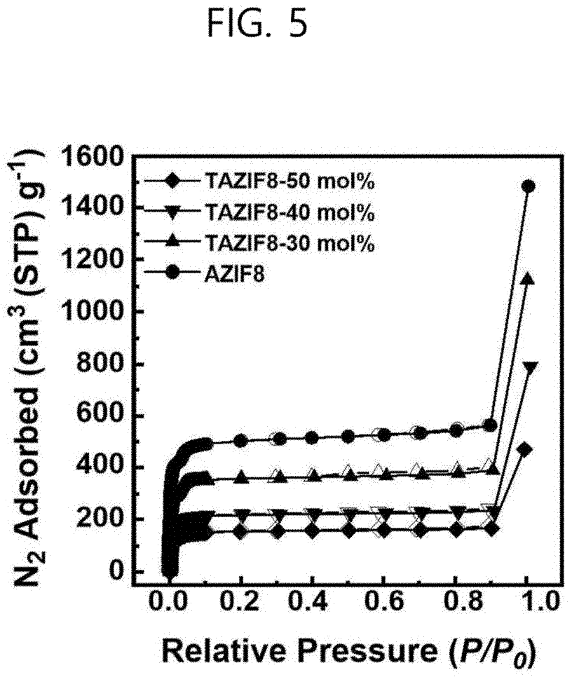

For the surface area analysis of TAZIF8 nanoparticles introduced with the Atz group, the Brunauer-Emmett-Teller (BET) equation was used from the N₂ adsorption isotherm and compared with the raw nanomaterials. The measurement was carried out under N₂ 77K conditions using Micromeritics ASAP 2020, and the particles were used after pretreatment for 3 hours under 120° C. vacuum condition before N₂ adsorption measurement. As shown in FIG. 5 and Table 2, when comparing isothermal analysis graphs according to pressure changes of raw nanoparticles and TAZIF8 nanoparticles, it was confirmed that the amount of N₂ adsorption, specific surface area, and pore volume gradually decreased as the amount of Atz introduced increased. This can be interpreted as that the particle surface area and pore size decreased due to the introduction of the Atz group, which has a larger volume than 2mim constituting the SOD structure, and thus the amount of adsorption to N₂ decreased.

TABLE 2
Specific surface area and pore
volume of synthetic particles using BET

| | specific surface area | pore volume |
|---|---|---|
| Sample | (m² g⁻¹) | (cm³ g) |
| Raw nanoparticles | 1920 | 0.71 |
| TAZIF8-30 mol % | 850 | 0.58 |
| TAZIF8-40 mol % | 660 | 0.39 |
| TAZIF8-50 mol % | 476 | 0.25 |

Scanning Electron Microscope Analysis

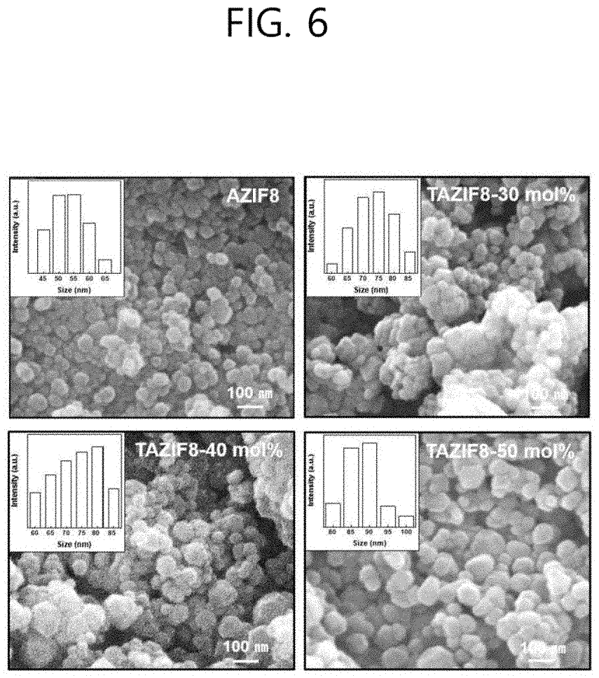

FIG. 6 is a scanning electron microscope (SEM) photograph of raw nanoparticles, TAZIF8-30 mol %, TAZIF8-40 mol %, and TAZIF8-50 mol % nanoparticles. The equipment used a voltage of 5.0 kV based on JSM-7100F. The raw nanoparticles showed a particle size of about 60 nm, whereas the TAZIF8 particles showed a maximum particle size of about 100 nm as the amount of Atz was increased.

Crystal Plane Peak Analysis

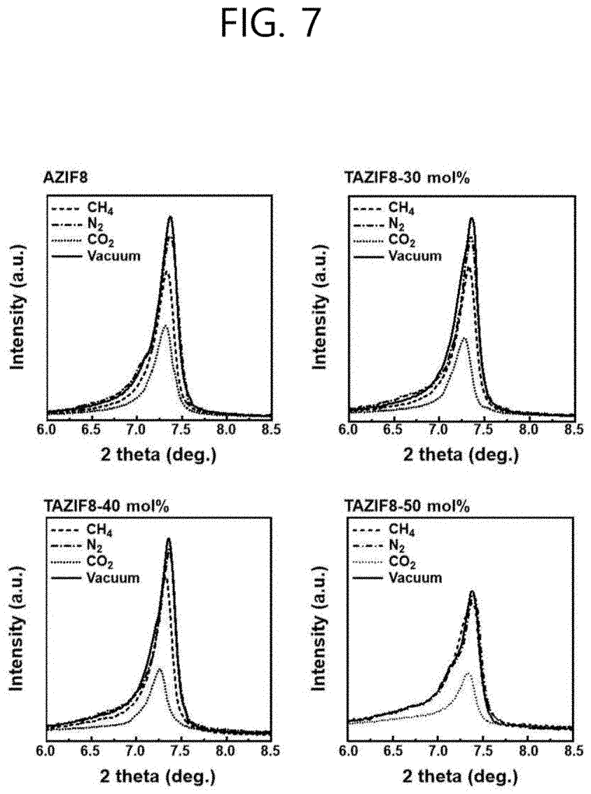

To confirm the possibility of selective CO₂ interaction and pore size change of TAZIF8 nanoparticles, a real-time X-ray diffraction analyzer (In-situ XRD) was used to adsorb CO₂, N₂, and CH₄ gases under isothermal conditions at 1 atm and 35° C., and the changes in the peak values and the peak area values of the (011) crystal plane of the particles were compared. X'Pert Pro equipment was used and the conditions of 60 kV and 60 mA were applied. As shown in FIG. 7, changes were observed when CO₂, N₂, and CH₄ gases were exposed to nanoparticles based on the peak value and the peak area value of the (011) crystal plane for each particle under a 35° C. vacuum condition.

As shown in Table 3, as a result of confirming the change in the (011) crystal plane peak value observed after exposing each nanoparticle to vacuum conditions, the raw nanoparticles showed a change of about 0.05 deg. whereas the TAZIF8 nanoparticles showed little change in the (011) crystal plane peak value even after exposure to vacuum conditions. This means that the pore size of the TAZIF8 nanoparticles was limited compared to the native nanoparticles. After exposing each nanoparticle exposed to vacuum conditions to CO₂ gas (011), and the change in the crystal plane peak value was observed, in the case of raw nanoparticles, it shows a change of about 0.05 deg, whereas TAZIF8-30 mol % shows a change of 0.07 deg., and TAZIF8-40 mol % shows a change of 0.09 deg. This can be interpreted as an improvement in the amount of CO₂ gas adsorption due to the amine group in the Atz group introduced into the TAZIF8 nanoparticles even though the TAZIF8 nanoparticles have a limited pore size compared to the original nanoparticles. On the other hand, TAZIF8-50 mol % is 0.05 deg., which can be interpreted as a decrease in the adsorption amount because the pore size in the nanoparticles is very limited, and CO₂ gas does not penetrate into the particles despite having an amine group.

TABLE 3
Comparison of (011) crystal plane peak values according to
in-situ XRD measurement conditions of synthetic particles

| | Atmospheric | | | | |
|---|---|---|---|---|---|
| | pressure | Vacuum | CO₂ | N₂ | CH₄ |
| | Peak | Peak | Peak | Peak | Peak |
| | position | position | position | position | position |
| Sample | (deg.) | (deg.) | (deg.) | (deg.) | (deg.) |
| Raw | 7.31 | 7.36 | 7.31 | 7.36 | 7.33 |
| nanoparticles | | | | | |
| TAZIF8-30 | 7.33 | 7.35 | 7.28 | 7.35 | 7.33 |
| mol % | | | | | |
| TAZIF8-40 | 7.35 | 7.35 | 7.26 | 7.36 | 7.33 |
| mol % | | | | | |
| TAZIF8-50 | 7.37 | 7.38 | 7.33 | 7.38 | 7.38 |
| mol % | | | | | |

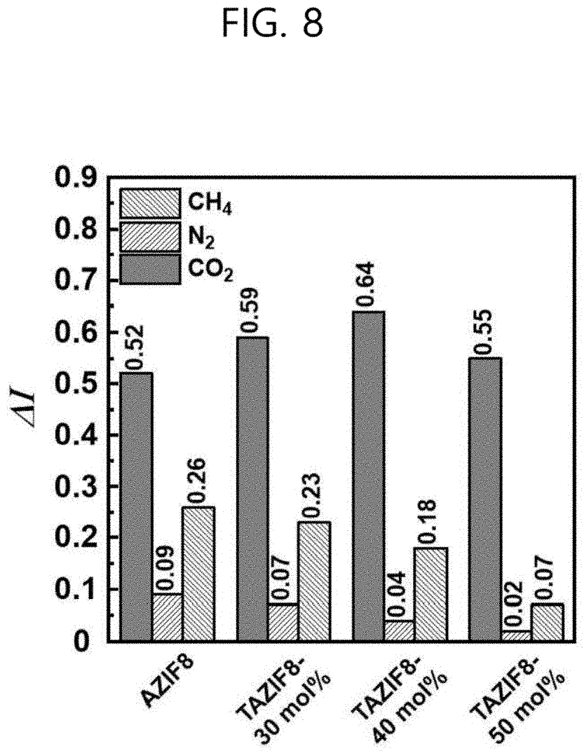

As shown in FIG. 8, it was confirmed that the amount of CO₂ adsorption of TAZIF8 nanoparticles increased compared to that of raw nanoparticles as the amount of Atz group introduced increased. ΔI represent the ratio of the peak area of the (011) crystal plane for each particle measured under vacuum conditions and the peak area of the (011) crystal plane decreased after gas adsorption. A larger ΔI mean a higher adsorption for a specific gas.

On the other hand, in the case of N₂ and CH₄ gases, it was confirmed that the adsorption amount gradually decreased as the amount of Atz introduced increased. This is a result similar to the result of the N₂ isothermal adsorption experiment, as the Atz group, which is larger than the 2mim organic ligand, was introduced, the specific surface area and pore volume of the particles decreased, and at the same time, it was shown that it was difficult for the gas to pass through the pores of the TAZIF8 particle due to the strong bonding force between the metal and the organic ligand. In addition, in the case of TAZIF8-50 mol % nanoparticles, the amount of CO₂ adsorption decreased compared to TAZIF8-40 mol % nanoparticles; this indicates that when an excessive amount of Atz group is introduced, the amount of adsorption to CO₂ gas can be decreased due to the above reasons.

Membrane Manufacturing and SEM Analysis

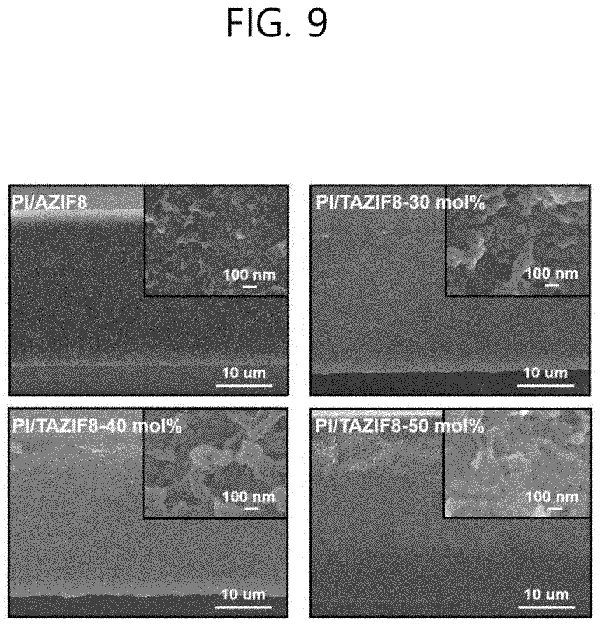

A hybrid membrane was prepared by mixing AZIF8, TAZIF8-30 mol %, TAZIF8-40 mol %, or TAZIF8-50 mol % with 6FDA-DAM polyimide (PI) polymer at a weight ratio of 60 (polymer)/40 (nanoparticle). AZIF8, TAZIF8-30 mol %, TAZIF8-40 mol %, and TAZIF8-50 mol % nanoparticles were mixed with a solvent (N-methyl-2-pyrrolidone, NMP) in a glass bottle for 1 hour, and each nanoparticle was uniformly dispersed in the solvent through an ultrasonic mill. Each nanoparticle was uniformly dispersed in the solvent for 30 seconds using a cone-shaped ultrasonicator. After mixing 6FDA-DAM polymer in a solvent in which each nanoparticle is uniformly dispersed and stirring through a roller for 12 hours, a glass bottle containing a uniformly dissolved polymer solution was placed in an ultrasonic grinder for 30 minutes to remove microbubbles in the solution, and the polymer solution was spread on a glass plate with a thin layer of 250 μm using a casting knife and dried under vacuum conditions at 120° C. for 12 hours. After 12 hours, the vitrified hybrid membrane was dried once again under vacuum conditions at 120° C. for 12 hours to remove residual solvent. The hybrid membrane obtained at this time exhibited a thickness of about 35 to 45 μm (FIG. 9).

FIG. 9 is an SEM photograph of a cross-section of each membrane. As a result of photographing, it was confirmed that the raw nanoparticles, TAZIF8-30 mol %, TAZIF8-40 mol %, and TAZIF8-50 mol % particles were all very uniformly dispersed in the polymer matrix without agglomeration of the particles.

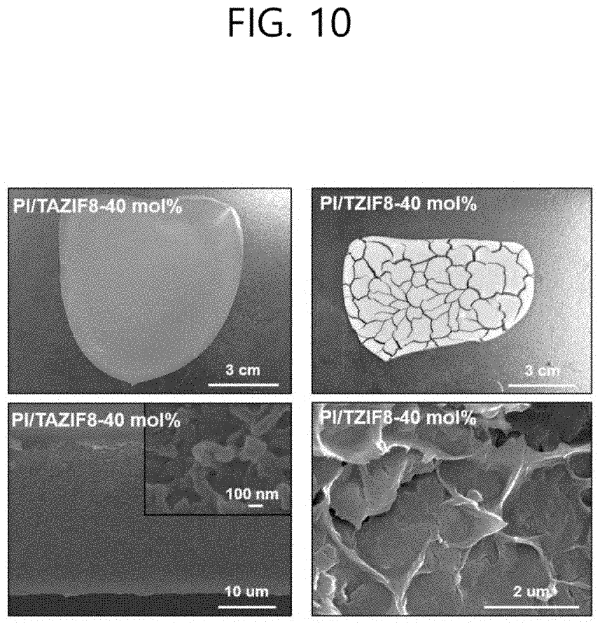

In order to observe the effect by the presence or absence of the second ligand, by using TAZIF8-40 mol % nanoparticles introduced with the second ligand and TZIF8-40 mol % nanoparticles omitting the second ligand, a hybrid membrane having 40 wt % nanoparticle was formed. As shown in FIG. 10, it was confirmed that the hybrid separation membrane including nanoparticles into which the second ligand was not introduced was broken at the same time as the film was formed. As a result of analyzing the cross section of the separation membrane by SEM, it was confirmed that all the TZIF8-40 mol % nanoparticles without the introduction of the second ligand were all agglomerated or clustered in the polymer matrix, and it showed low compatibility with the polymer.

Measurement of Physical Properties of Hybrid Membranes

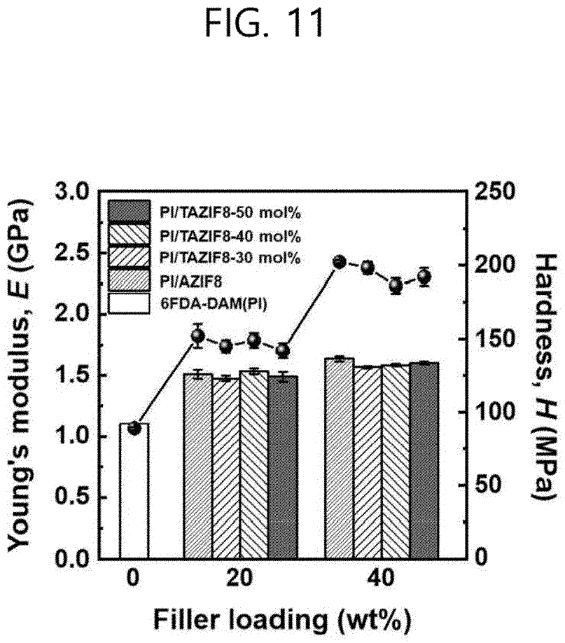

The mechanical properties of the hybrid membrane, Young's modulus and hardness, were measured using a nanoindenter. The mechanical properties were measured by pressing the Berkovich tip into the surface 5 times with a load of 2,500 uN using the TI-950 equipment. As shown in FIG. 11, it was confirmed that the hybrid membrane maintained high mechanical properties without significant decrease in Young's modulus and hardness compared to a single PI polymer, regardless of the amount of Atz introduced.

Analysis of Gas Separation Performance of Hybrid Membrane

Table 4 shows the CO₂, N₂, CO, and CH₄ single gas separation performance of all hybrid membranes prepared including PI polymer under isothermal conditions at 1 atm pressure and 35° C. The single gas permeability test of each hybrid membrane was evaluated using a fixed volume-variable permeation system. As a result of the experiment, it was confirmed that the CO₂ permeability simultaneously increased as the amount of Atz introduced into the TAZIF8 particles increased, compared to the PI/AZIF8 hybrid membrane.

It is considered that selective CO₂ permeation occurred through the interaction of the amine group in AZIF8-Atz with CO₂ gas. On the other hand, as the amount of Atz introduced increases, the permeability of N₂, CO, and CH₄ gases gradually decreases, this means that it is difficult for all gases except CO₂ to pass through the pores of the particle because the pore size of the particles becomes smaller after the introduction of the Atz organic ligand in AZIF8.

In the case of TAZIF8-40 mol % nanoparticles, the hybrid membrane containing a 40 weight % of nanoparticle had a CO₂ permeability of 1638 Barrer, a CO₂/N₂ selectivity of 42.5, a CO₂/CO selectivity of 28.7, and a CO₂/CH₄ selectivity of 44.2 without particle agglomeration, and it was confirmed that high selectivity is possible. On the other hand, in the case of the hybrid membrane containing TAZIF8-50 mol % of 40 nanoparticles weight %, the CO₂/N₂ selectivity was 54.6, the CO₂/CO selectivity was 36.1, and the CO₂/CH₄ selectivity was 45.6, and it showed improved selectivity, but the CO₂ permeability was lower than the PI/TAZIF8-40 mol % membrane containing the same weight ratio as 891.54 Barrer. This means that the excess Atz group introduced into the TAZIF8-50 mol % nanoparticles reduces the specific surface area and pore volume of the particles, at the same time, and this means that it is difficult for the gas to pass through the pores of the TAZIF8 particle due to the strong bonding force between the metal and the organic ligand.

TABLE 4
CO₂, N₂, CO, CH₄ gas separation performance of PI and hybrid membranes
under isothermal conditions at 35° C. at 1 atmosphere

| | Amount | P_{CO2} | P_{N2} | P_{CO} | P_{CH4} | CO₂/ | CO₂/ | CO₂/ |
|---|---|---|---|---|---|---|---|---|
| Sample | (wt %) | (Barrer) | (Barrer) | (Barrer) | (Barrer) | N₂ (—) | CO (—) | CH₄ (—) |
| PI | — | 599.48 | 27.86 | 42.04 | 25.64 | 21.5 | 14.5 | 23.4 |
| PI/AZIF8 | 20 | 888.24 | 43.15 | 60.52 | 43.92 | 21.6 | 14.7 | 20.2 |
| | 40 | 1067.35 | 54.24 | 79.42 | 55.75 | 19.7 | 13.4 | 19.1 |
| PI/TAZIF8- | 20 | 908.04 | 32.15 | 50.40 | 36.81 | 28.2 | 18.0 | 24.7 |
| 30 mol % | 40 | 1410.39 | 42.77 | 62.02 | 44.19 | 33.0 | 22.7 | 31.9 |
| PI/TAZIF8- | 20 | 963.73 | 29.00 | 44.08 | 29.62 | 33.2 | 21.9 | 32.5 |
| 40 mol % | 40 | 1638.04 | 38.59 | 57.12 | 37.06 | 42.4 | 28.7 | 44.2 |
| PI/TAZIF8- | 40 | 891.54 | 16.32 | 24.67 | 19.54 | 54.6 | 36.1 | 45.6 |
| 50 mol % | | | | | | | | |

In order to more accurately analyze the gas permeation/adsorption mechanism of TAZIF8 nanoparticles, a 35° C. isothermal adsorption experiment for CO₂, N₂, and CH₄ gases of a hybrid membrane containing 40 weight % of nanoparticle was performed. As shown in FIG. 11, the amount of CO₂ adsorption of the hybrid membrane including TAZIF8 nanoparticles with increased Atz introduction increased, and the amount of CO₂ adsorption of the PI/TAZIF8-50 mol % membrane decreased compared to the PI/TAZIF8-40 mol % membrane. The results were like those of the gas permeability experiment. On the other hand, the amount of N₂ and CH₄ gas adsorption decreased as the amount of Atz introduced increased as the hybrid membrane including TAZIF8 nanoparticles increased. Based on the isothermal adsorption experiment, the adsorption behavior of each hybrid membrane was compared by using a dual mode model combining Henry's law and Langmuir's law, and it is shown in Table 5.

Based on the results of the isothermal adsorption experiment, the adsorption behavior of the developed hybrid membrane was analyzed using the dual mode model equation consisting of the sum of the Henry model and the Langmuir model.

$${C}_{i} = {k}_{D , i} {p}_{i} + \frac{{C}_{H , i}^{′} {b}_{i} {p}_{i}}{1 + {b}_{i} {p}_{i}}$$

Cᵢ (cm³ (STP) cm⁻³ (polymer)) is the concentration of gas i in the hybrid membrane, pᵢ is the partial pressure of gas i in the equilibrium state, CHᵢ (cm³ (STP) cm⁻³ (polymer)) is the Langmuir adsorption constant for gas i, bᵢ (atm⁻¹) is the affinity constant for gas i, and k_{D,i} (cm³ (STP) cm⁻³ (polymer) atm⁻¹) is the Henry constant for gas i. All nanoparticles were dried at 35° C. for 12 hours under vacuum conditions prior to adsorption experiments. As shown in Table 5, the hybrid membrane including TAZIF8 nanoparticles with increased Atz introduction improved the selective interaction with CO₂, so that all C′_{H}, b, and k_{D} variables continued to increase up to the PI/TAZIF8-40 mol % membrane, and these model parameters decrease again because the surface area and pores are significantly reduced in the PI/TAZIF8-50 mol % membrane. On the other hand, the variables for N₂ and CH₄ gases decrease the surface area and pore volume of nanoparticles as the amount of Atz is increased, and it was confirmed that all PI/TAZIF8 MMMs have reduced C′_{H} compared to PI/AZIF8. This result indicates that TAZIF8 nanoparticles are capable of selective interaction with CO₂ and decrease the adsorption amount without special interaction with respect to N₂ and CH₄.

TABLE 5
CO₂, N₂, and CH₄ dual mode model parameter values of the
developed hybrid membrane containing nanoparticles in
a 40 weight ratio under 35° C. isothermal conditions

| | CO₂ | | | N₂ | | | CH₄ | | |
|---|---|---|---|---|---|---|---|---|---|
| Sample | C_{H}^{′} | b | k_{D} | C_{H}^{′} | b | k_{D} | C_{H}^{′} | b | k_{D} |
| PI | 36.60 | 0.52 | 1.86 | 0.55 | 0.33 | 0.54 | 4.47 | 0.40 | 1.15 |
| PI/AZIF8 | 41.59 | 0.70 | 2.33 | 1.33 | 0.46 | 0.75 | 7.54 | 0.46 | 1.36 |
| PI/TAZIF8- | 47.31 | 0.87 | 3.05 | 0.95 | 0.41 | 0.72 | 5.67 | 0.55 | 1.33 |
| 30 mol % | | | | | | | | | |
| PI/TAZIF8- | 48.95 | 1.16 | 4.12 | 0.86 | 0.36 | 0.68 | 4.73 | 0.55 | 1.40 |
| 40 mol % | | | | | | | | | |
| PI/TAZIF8- | 42.81 | 0.79 | 2.65 | 0.43 | 0.40 | 0.53 | 4.50 | 0.50 | 1.28 |
| 50 mol % | | | | | | | | | |

In the dense polymer membrane, gas permeability (Pᵢ) may be expressed as the product of diffusivity (Dᵢ), which is a dynamic factor, and solubility (Sᵢ), which is a thermodynamic factor.

Pᵢ=Dᵢ×Sᵢ

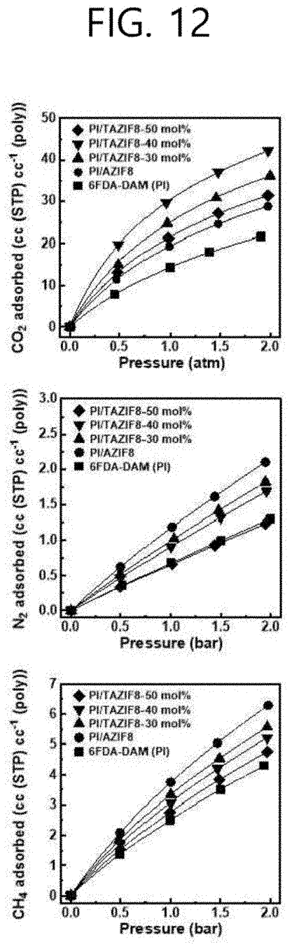

Based on the adsorption amount for each gas calculated in FIG. 12, the gas permeability of Table 4 is divided into diffusivity and solubility and is shown in Table 6. It was confirmed that as the amount of Atz introduced increased, the gas diffusivity of the PI/TAZIF8 hybrid membrane decreased regardless of the type of gas. On the other hand, it was confirmed that the diffusivity selectivity of CO₂/N₂ and CO₂/CH₄ increased. On the other hand, it was confirmed that the selectivity of the CO₂/N₂ and CO₂/CH₄ diffusivity increased, this can be interpreted because the pore size decreased due to the improved binding force between the Zn metal ion and the organic ligand after the introduction of the Atz group, and the separation ability through the gas size was improved. In the case of solubility, it was confirmed that the adsorption amount for CO₂ was selectively increased after the introduction of the Atz group, but the solubility was gradually decreased for N₂ and CH₄. In particular, in the case of the PI/TAZIF8-50 mol % membrane, the decrease in the solubility of N₂ and CH₄ was higher than the decrease in the solubility of CO₂, despite the decrease in the solubility of all gases compared to the PI/TAZIF8-40 mol % membrane. It was confirmed that the solubility selectivity for CO₂/CH₄ was maintained like that of the PI/TAZIF8-40 mol % membrane.

TABLE 6
Diffusivity, solubility, diffusivity selectivity, and solubility
selectivity of the developed hybrid membrane containing nanoparticles
in a 40 weight ratio under the conditions of 1 atm and 35° C.

| | | | | Diffusivity | | Solubility | |
|---|---|---|---|---|---|---|---|
| | | | | selectivity | | selectivity | |
| | | ^{a}Diffusivity | ^{b}Solubility | CO₂/ | CO₂/ | CO₂/ | CO₂/ |
| Sample | Gas | (D) | (S) | N₂ | CH₄ | N₂ | CH₄ |
| PI | CO₂ | 3.20 | 18.71 | 1.0 | 4.1 | 21.3 | 5.7 |
| | N₂ | 3.11 | 0.88 | | | | |
| | CH₄ | 0.78 | 3.30 | | | | |
| PI/AZIF8 | CO₂ | 4.42 | 24.13 | 1.3 | 3.9 | 15.4 | 5.0 |
| | N₂ | 3.46 | 1.57 | | | | |
| | CH₄ | 1.13 | 4.82 | | | | |
| PI/TAZIF8- | CO₂ | 4.31 | 32.72 | 1.3 | 4.3 | 25.2 | 7.5 |
| 30 mol % | N₂ | 3.28 | 1.30 | | | | |
| | CH₄ | 1.01 | 4.38 | | | | |
| PI/TAZIF8- | CO₂ | 4.14 | 39.57 | 1.4 | 4.7 | 31.5 | 9.4 |
| 40 mol % | N₂ | 3.02 | 1.28 | | | | |
| | CH₄ | 0.92 | 4.03 | | | | |
| PI/TAZIF8- | CO₂ | 3.19 | 27.97 | 1.7 | 5.9 | 31.8 | 7.7 |
| 50 mol % | | | | | | | |

*^{a}diffusivity (×10⁻⁷ cm² sec⁻¹)
*^{b}solubility (×10⁻² cm³ (STP) cm⁻³ cmHg⁻¹)

What is claimed is:

1. Nanoparticles of a zeolitic Imidazolate framework (ZIF) into which three kinds of ligands are introduced, the nanoparticles comprising:
metal ions; and
an organic ligand bound to the metal ion,
wherein the organic ligand comprises wherein the organic ligand comprises an imidazole-based first organic ligand, alkylamine-based second organic ligand, and third organic ligand comprising at least one amine group substituted on the ring.

2. The nanoparticles according to claim 1, wherein, in the organic ligand, the third organic ligand is 20 to 60 mol %.

3. The nanoparticles according to claim 1, wherein the organic ligand comprises 30 to 80 mol % of the first organic ligand, 3 to 15 mol % of the second organic ligand, and 20 to 60 mol % of the third organic ligand.

4. The nanoparticles according to claim 1, wherein the first organic ligand, the second organic ligand and the third organic ligand are each directly bonded to the metal ion nanoparticles.

5. The nanoparticles according to claim 1, wherein the first organic ligand comprises at least one of primary, secondary, and tertiary amines, and contains one or more selected from the group of alkylamines having an alkyl chain of any one length of methyl, ethyl, propyl, butyl, pentyl, hexyl, heptyl, octyl, nonyl, decyl, undecyl, dodecyl, propadecyl, butadecyl, pentadecyl, hexadecyl, heptadecyl, octadecyl, and nodadecyl.

6. The nanoparticles according to claim 1, wherein the second organic ligand comprises at least one selected from 2-methylimidazole, imidazole, ethylimidazole, nitroimidazole, chloromethylimidazole, dichloroimidazole, imidazole-4-carboxamide, aminobenzimidazole, benzimidazole, 5-chlorobenz imidazole, 5,6 dimethylbenzimidazole, methylbenzimidazole, bromobenzimidazole, and nitrobenzimidazole.

7. The nanoparticles according to claim 1, wherein the third organic ligand comprises at least one selected from amino-1,2,4-triazole, aminoimidazole, 2-aminobenzimidazole, and 6-aminobenzimidazole.

8. The nanoparticles according to claim 1, wherein the spacing between the (011) crystal planes of the nanoparticles is 12.06 to 11.95 Å, the IR peak of the amine-metal bond of the nanoparticles is 425.5 to 429.5 cm′, the specific surface area of the nanoparticles is 400 to 1000 m² g⁻¹, the pore volume is 0.2 to 0.65 cm³ g⁻¹, and the size of the nanoparticles is 80 nm to 120 nm.

9. A method manufacturing nanoparticles of a zeolitic imidazolate framework (ZIF) into which three kinds of ligands are introduced, the method comprising:
agitating a metal precursor, an imidazole-based first organic ligand, and an alkylamine-based second organic ligand in a first polar solvent to obtain raw nanoparticles; and
substituting at least a portion of the first organic ligand and the second organic ligand of the raw nanoparticles with a third organic ligand comprising at least one amine group substituted on a ring.

10. The method according to claim 9 wherein the substituting is performed by agitating the raw nanoparticles and the third organic ligand in a second polar solvent.

11. The method according to claim 10 wherein the metal precursor comprises an acetate salt of one or more metals selected from the group consisting of Co, Zn, Sc, Ti, V, Cr, Mn, Fe, Ni, Cu, Y, Zr, Nb, Mo, Tc, Ru, Rh, Pd, Ag, Cd, Lu, Hf, Ta, W, Re, Os, Ir, Pt, Au, Hg, Lr, Rf, db, Sg, Bh, Hs, Mt, Ds, Rg, and Uub, and
the first polar solvent and the second polar solvent each independently comprise at least one selected from the group consisting of alcohol, methanol, ethanol, propanol, ethylene glycol, water, dimethylformamide, dimethyl sulfoxide, acetonitrile, and dimethylacetamide.

12. A hybrid membrane comprising nanoparticles, the hybrid membrane comprising:
100 parts by weight of a polymer; and
a hybrid membrane comprising 30 to 150 parts by weight of the nanoparticles according to claim 1.

13. The hybrid membrane of claim 12, wherein the hybrid membrane has a CO₂/N₂ separation performance of 25 to 60, a CO₂/CO separation performance of 15 to 60, and a CO₂/CH₄ separation performance of 24 to 50 at 1 atmospheric pressure and 35° C.
